(19) United States
(12) Patent Application Publication
(10) Pub. No.: US 2026/0025581 A1
(43) Pub. Date: Jan. 22, 2026

(54) IMAGE PROCESSING APPARATUS AND METHOD, IMAGE CAPTURING APPARATUS, IMAGE CAPTURING SYSTEM, AND STORAGE MEDIUM FOR EVALUATING AND ANALYZING FOCUS STATE

(71) Applicant: CANON KABUSHIKI KAISHA, Tokyo (JP)

(72) Inventors: HIDEKI OGURA, Kanagawa (JP); YOHEI MATSUI, Kanagawa (JP); AKIHIKO KANDA, Kanagawa (JP)

(21) Appl. No.: 19/275,334

(22) Filed: Jul. 21, 2025

(30) Foreign Application Priority Data
Jul. 22, 2024 (JP) 2024-117232

(51) Int. Cl. H04N 23/67; H04N 23/63

(52) U.S. Cl. CPC H04N 23/675; H04N 23/632; H04N 23/672

(57) ABSTRACT

An image processing apparatus comprises an acquisition unit that acquires, from a storage unit, a captured image, information indicating a focus state of the image, and information indicating first settings at the time of image capture; a calculation unit that calculates an alternative focus state of the image if it was captured using second settings different from the first settings; and a control unit that displays on a display unit information representing the focus state acquired by the acquisition unit and information representing the alternative focus state calculated by the calculation unit.

### BACKGROUND

### Field of the Technology

The present disclosure relates to an image processing apparatus and method, an image capturing apparatus, an image capturing system, and a storage medium.

### Description of the Related Art

As a method for evaluating captured images, Japanese Patent Laid-Open No. 2019-159182 discloses a method of performing a plurality of different image processing operations on an arbitrary image signal and comparing and displaying the image qualities of the plurality of images obtained as the results of the different image processing operations.

However, as disclosed in Japanese Patent Laid-Open No. 2019-159182, although it is possible to compare image qualities which may differ depending on differences in image processing, no evaluation or analysis is performed on focus states that may result from changing the settings at the time of capturing.

### SUMMARY

The present disclosure has been made in consideration of the above situation, and, based on a captured image, evaluation and analysis are performed on focus states that may result from changing the settings at the time of capturing an image.

According to the present disclosure, provided is an image processing apparatus comprising one or more memories storing a program and one or more processors that, upon execution of the stored program, are configured to function as: an acquisition unit that acquires, from a storage unit, a captured image, information indicating a focus state of the image, and information indicating first settings at the time of image capture; a calculation unit that calculates an alternative focus state of the image as if it was captured using second settings different from the first settings; and a control unit that displays on a display unit information representing the focus state acquired by the acquisition unit and information representing the alternative focus state calculated by the calculation unit.

Further, according to the present disclosure, provided is an image capturing apparatus comprising: an image processing apparatus comprising one or more memories storing a program and one or more processors that, upon execution of the stored program, are configured to function as: an acquisition unit that acquires, from a storage unit, a captured image, information indicating a focus state of the image, and information indicating first settings at the time of image capture; a calculation unit that calculates an alternative focus state of the image as if it was captured using second settings different from the first settings; and a control unit that displays on a display unit information representing the focus state acquired by the acquisition unit and information representing the alternative focus state calculated by the calculation unit; and an image sensor, wherein the image is captured by the image sensor and stored in the storage unit.

Furthermore, according to the present disclosure, provided is an image capturing system comprising: a first image capturing apparatus; an image processing apparatus comprising one or more memories storing a program and one or more processors that, upon execution of the stored program, are configured to function as: an acquisition unit that acquires, from a storage unit, an image captured by the first image capturing apparatus, information indicating a focus state of the image, and information indicating first settings at the time of image capture; a calculation unit that calculates an alternative focus state of the image as if it was captured using second settings different from the first settings; and a control unit that displays on a display unit information representing the focus state acquired by the acquisition unit and information representing the alternative focus state calculated by the calculation unit, wherein the second settings are settings of functions of a second image capturing apparatus different from the first image capturing apparatus that captured the image; and a storage device that stores information about the functions of the second image capturing apparatus.

Further, according to the present disclosure, provided is an image processing method comprising: acquiring, from a storage unit, a captured image, information indicating a focus state of the image, and information indicating first settings at the time of image capture; calculating an alternative focus state of the image as if it was captured using second settings different from the first settings; and displaying, on a display unit, information representing the acquired focus state and information representing the calculated alternative focus state.

Further, according to the present disclosure, provided is a non-transitory computer-readable storage medium, the storage medium storing a program that is executable by a computer, wherein the program includes program code for causing the computer to execute an image processing method comprising: acquiring, from a storage unit, a captured image, information indicating a focus state of the image, and information indicating first settings at the time of image capture; calculating an alternative focus state of the image as if it was captured using second settings different from the first settings; and displaying, on a display unit, information representing the acquired focus state and information representing the calculated alternative focus state.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of a configuration of an image capturing system according to an embodiment of the present disclosure.

FIG. 2 is a block diagram illustrating a functional configuration of a camera according to the embodiment.

FIG. 3 is a conceptual diagram illustrating an example of a pixel array according to the embodiment.

FIGS. 4A and 4B are a schematic plan view and a schematic cross-sectional view, respectively, of a pixel according to the embodiment.

FIG. 5 is an explanatory diagram of focus detection areas according to the embodiment.

FIG. 6 is a block diagram illustrating the hardware configuration of a computing apparatus according to the embodiment.

FIG. 7 is a flowchart illustrating image shooting processing according to the embodiment.

FIG. 8 is a flowchart illustrating an image shooting subroutine according to the embodiment.

FIG. 9 is a diagram illustrating information stored according to the embodiment.

FIG. 10 is a flowchart illustrating image evaluation processing according to the embodiment.

FIG. 11 is a diagram illustrating an example of a shooting scene according to the embodiment.

FIG. 12 is an explanatory diagram of a defocus map display according to the embodiment.

FIGS. 13A and 13B are diagrams illustrating changes in degree of focus resulting from changes in setting conditions according to the embodiment.

FIG. 14 is a diagram illustrating an example of degrees of focus in a series of images according to the embodiment.

FIG. 15 is a diagram illustrating a list of recommended settings according to the embodiment.

FIGS. 16A and 16B are diagrams illustrating an effect in a case where tracking is turned on according to the embodiment.

FIG. 17 is a diagram illustrating options of whether or not to turn on tracking according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals may be given to the same or similar configurations, and redundant descriptions thereof are omitted.

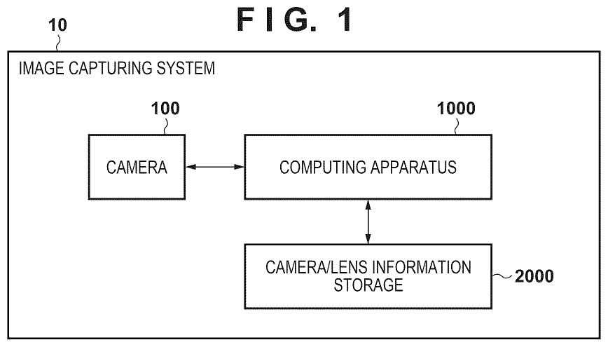

FIG. 1 is a block diagram illustrating an example of a configuration of an image capturing system 10 according to an embodiment of the present disclosure. The image capturing system 10 includes a camera 100, which is an image capturing apparatus, a computing apparatus 1000, and a camera/lens information storage 2000.

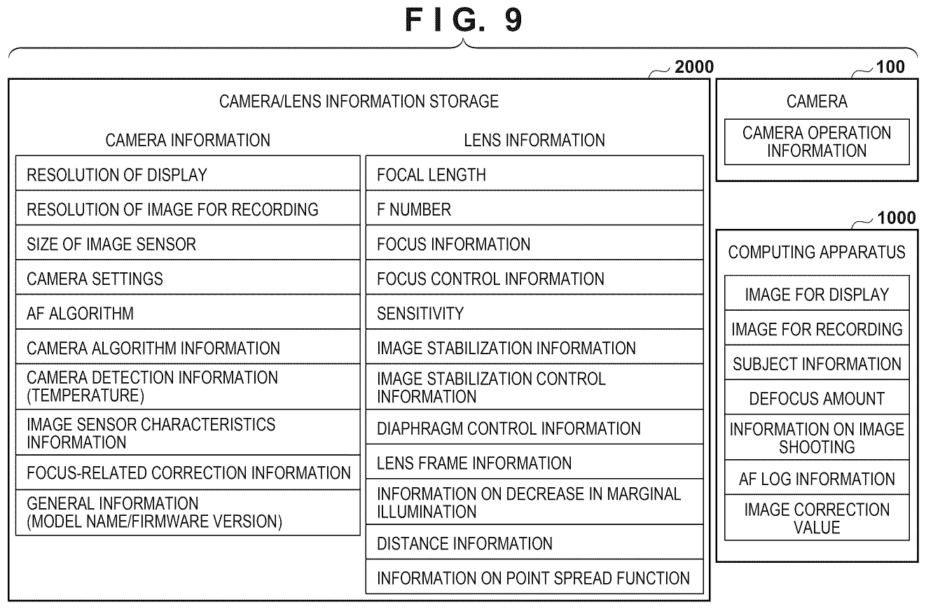

In FIG. 1, the camera 100 has a function of shooting an image of a subject. The computing apparatus 1000 is connected to the camera 100 via a wired or wireless connection so as to be able to transmit and receive information to and from the camera 100. The computing apparatus 1000 uses information obtained from the camera 100 to obtain related information from the camera/lens information storage 2000. The camera/lens information storage 2000 may be a server on a network such as a cloud, or may be provided within the computing apparatus 1000. The information stored in the camera/lens information storage 2000 will be described later with reference to FIG. 9.

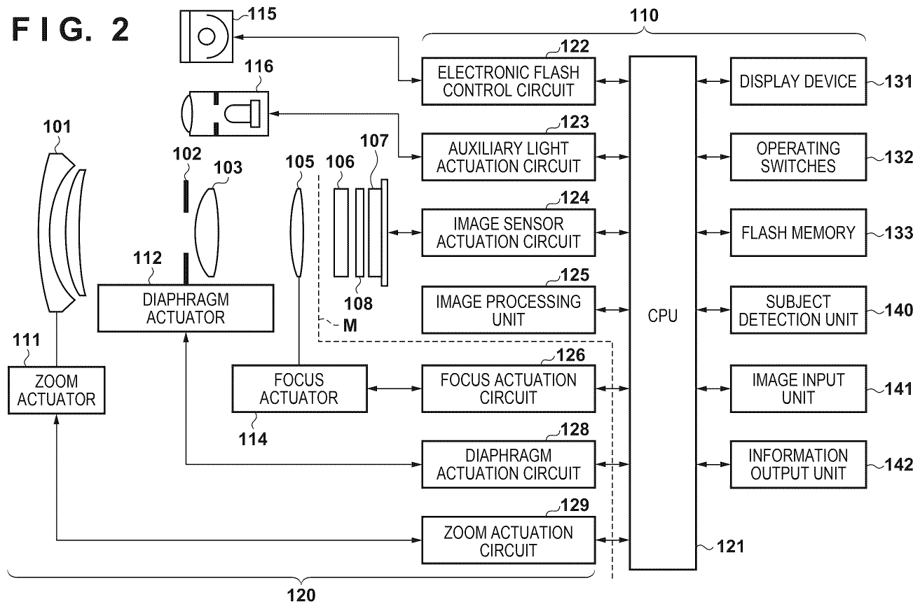

FIG. 2 illustrates a schematic configuration of the camera 100 in this embodiment. In FIG. 2, a first lens group 101 is disposed closest to the subject (front side) in an imaging optical system as an image forming optical system, and is held so as to be movable in the optical axis direction. A diaphragm 102 adjusts an amount of light by adjusting its aperture diameter. A second lens group 103 moves in the optical axis direction together with the diaphragm 102, and, as it moves in coordination with the movement of the first lens group 101 in the optical axis direction, magnification is changed (zoom).

A third lens group (focus lens) 105 moves in the optical axis direction to adjust the focus. An optical low-pass filter 108 is an optical element for reducing false colors and moiré in a captured image. The first lens group 101, the diaphragm 102, the second lens group 103, and the third lens group 105 constitute the imaging optical system.

A zoom actuator 111 rotates a cam barrel (not shown) around the optical axis, which moves the first lens group 101 and the second lens group 103 in the optical axis direction by cams provided on the cam barrel, thereby changing the magnification. A diaphragm actuator 112 actuates a plurality of light-shielding blades (not shown) of the diaphragm 102 in opening and closing directions to adjust the amount of light. A focus actuator 114 moves the third lens group 105 in the optical axis direction to adjust the focus.

A zoom actuation circuit 129 actuates the zoom actuator 111 in response to a command from a camera CPU 121. A diaphragm actuation circuit 128 actuates the diaphragm actuator 112 in response to a diaphragm actuation command from a camera CPU 121. A focus actuation circuit 126 actuates the focus actuator 114 in response to a focus actuation command from the camera CPU 121, and moves the third lens group 105 in the optical axis direction.

In this embodiment, an interchangeable lens 120 having the imaging optical system, the zoom actuator 111, the diaphragm actuator 112, the focus actuator 114, the focus actuation circuit 126, the diaphragm actuation circuit 128, and the zoom actuation circuit 129 is configured to be detachable from a camera body 110 via a mount part M that enables electrical and mechanical connection. However, the present disclosure is not limited to this, and the imaging optical system, the zoom actuator 111, the diaphragm actuator 112, the focus actuator 114, the focus actuation circuit 126, the diaphragm actuation circuit 128, and the zoom actuation circuit 129 may be configured to be integrally provided in the camera 100 having an image sensor 107.

An electronic flash 115 has a light-emitting element such as a xenon tube or an LED and emits light to illuminate a subject. An AF auxiliary light emission unit 116 has a light-emitting element such as an LED and improves focus detection performance for dark subjects or low-contrast subjects by projecting an image of a mask having a predetermined opening pattern onto the subject via a projection lens. An electronic flash control circuit 122 controls the electronic flash 115 to light up in synchronization with an image shooting operation. An auxiliary light actuation circuit 123 controls the AF auxiliary light emission unit 116 to light up in synchronization with a focus detection operation.

The camera CPU 121 performs various controls in the camera 100 and includes a computing unit, ROM, RAM, an A/D converter, a D/A converter, a communication interface circuit, etc. The camera CPU 121 actuates various circuits in the camera 100 and controls a series of operations such as AF, image shooting, image processing, and recording in accordance with a computer program stored in the ROM. The camera CPU 121 also functions as an image processing apparatus.

The image sensor 107 is comprised of a two-dimensional CMOS photosensor including a plurality of pixels and its peripheral circuits and is disposed on the imaging plane of the imaging optical system. The image sensor 107 photoelectrically converts an image of a subject formed by the imaging optical system. An image sensor actuation circuit 124 controls the operation of the image sensor 107. The image sensor actuation circuit 124 also converts an analog signal generated by the image sensor 107 to a digital signal through photoelectric conversion and transmits the converted digital signal to the camera CPU 121.

A shutter 106 has a focal plane shutter configuration and is actuated in response to a command from a shutter actuation circuit built into the shutter 106 based on an instruction from the camera CPU 121. The shutter 106 shields the image sensor 107 from light while a signal is being read out from the image sensor 107. Furthermore, when the image sensor 107 is being exposed, the shutter 106 is opened and passes light from a subject toward the image sensor 107.

An image processing unit 125 applies predetermined image processing to image data stored in the RAM within the camera CPU 121. The predetermined image processing applied by the image processing unit 125 includes, but is not limited to, so-called development processing such as white balance adjustment processing, color interpolation (demosaic) processing, and gamma correction processing, as well as signal format conversion processing and scaling processing. Furthermore, the image processing unit 125 determines a main subject based on posture information of a subject/subjects detected by a subject detection unit 140 described later and position information of an object unique to the scene (hereinafter, unique object). The result of the determination processing may be used for other image processing (for example, white balance adjustment processing and focus adjustment processing). The image processing unit 125 saves the processed image data, the joint positions of each subject, the position and size information of the unique object, the center of gravity of the subject determined to be the main subject, position information of a face, eyes, etc. in the RAM within the camera CPU 121.

A display device 131 has a display element such as an LCD and displays information regarding a shooting mode of the camera 100, a preview image before image shooting, a confirmation image after image shooting, an indicator for a focus detection area, an in-focus image, etc.

Operating switches 132 include a main (power) switch, a release (shooting trigger) switch, a zoom operation switch, a shooting mode selection switch, etc., and are operated by a user. A flash memory 133 stores captured images. The flash memory 133 may be detachable from the camera 100.

When performing shooting (generating an image), an image input unit 141 inputs a generated image, and the camera CPU 121 performs processing such as displaying the input image on the display device 131 and storing it in the flash memory 133.

When performing shooting, an information output unit 142 outputs various information such as camera operation information, camera setting information, and camera control information to the computing apparatus 1000. The camera operation information includes a release operation that instructs shooting, information related to framing, a zooming operation, a focus operation, and other button operations. The camera setting information includes setting information related to the mode when performing continuous shooting, autofocus, photometry, exposure condition settings, image generation, lens control, and the like. The camera control information includes information related to correction values, thresholds, and the like used in various algorithms used in shooting and image generation. The information output unit 142 also outputs information indicating the camera position and the shooting direction.

The subject detection unit 140 performs subject detection based on dictionary data sets generated by machine learning. In this embodiment, in order to detect a plurality of types of subjects, the subject detection unit 140 uses a dictionary data set prepared for each type of subject. Each dictionary data set is, for example, a data set in which the characteristics of the corresponding subject type are registered. The subject detection unit 140 performs subject detection while sequentially switching the dictionary data set for each subject type. The dictionary data set for each subject type is stored in a dictionary data storage unit (here, a ROM in the camera CPU 121). Therefore, a plurality of dictionary data sets are stored in the dictionary data storage unit. The camera CPU 121 determines which of the plurality of dictionary data sets is to be used to perform subject detection based on priorities of subjects set in advance and the settings of the camera 100.

The kinds of dictionary data sets for subject detection include, for example, a dictionary data set for detecting a “person” as a subject, a dictionary data set for detecting an “animal”, a dictionary data set for detecting a “vehicle”, etc. Furthermore, a dictionary data set for detecting an “entire person” and a dictionary data set for detecting a “person's face” may be stored separately in the dictionary data storage unit.

In this embodiment, the subject detection unit 140 is configured by a machine-learned convolutional neural network (CNN), and estimates the area, position, etc. of a subject included in image data based on the generated dictionary data sets. The subject detection unit 140 may be realized by a graphics processing unit (GPU) or a circuit specialized for estimation processing by a CNN.

The machine learning of the CNN may be performed using an arbitrary method. For example, a specific computer such as a server may perform machine learning of the CNN, and the camera 100 may acquire the learned CNN from the specific computer. For example, the specific computer may perform supervised learning using image data for learning as input and the position of the subject corresponding to the image data for learning as ground truth data, thereby performing learning of the CNN used in the subject detection unit 140. In this way, a learned CNN is generated. The CNN may also be trained within the camera 100.

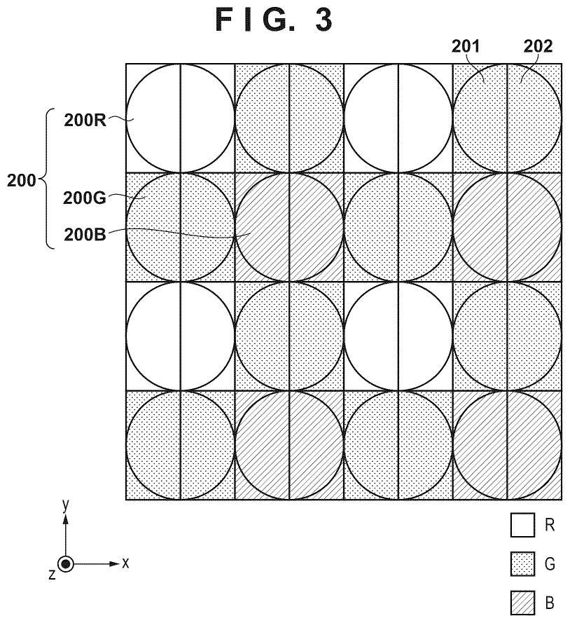

Next, the pixel array of the image sensor 107 will be described with reference to FIG. 3. FIG. 3 illustrates a pixel array of 4 columns×4 rows of pixels among pixels (imaging pixels) constituting the image sensor 107, as viewed from the optical axis direction (z direction).

Each pixel group 200 includes four imaging pixels arranged in 2 rows×2 columns. By arranging a large number of pixel groups 200 on the image sensor 107, photoelectric conversion of a two-dimensional optical image of a subject can be performed. Of each pixel group 200, an imaging pixel (hereinafter referred to as an “R pixel”) 200R having a spectral sensitivity of R (red) is arranged at the upper left, and imaging pixels (each referred to as a “G pixel” hereinafter) 200G having a spectral sensitivity of G (green) are arranged at the upper right and lower left. Furthermore, an imaging pixel (hereinafter referred to as a “B pixel”) 200B having a spectral sensitivity of B (blue) is arranged at the lower right. Each imaging pixel includes a first focus detection sub-pixel 201 and a second focus detection sub-pixel 202 dividing each imaging pixel in the horizontal direction (x direction).

In this embodiment, a case will be described in which each imaging pixel is divided into two in the horizontal direction, but it may also be divided in the vertical direction. Also, the image sensor 107 in this embodiment has a plurality of imaging pixels, each of which includes the first and second focus detection sub-pixels, but the first and second focus detection sub-pixels may be provided as focus detection pixels separate from the imaging pixels. For example, the focus detection pixels may be discretely arranged among the plurality of imaging pixels.

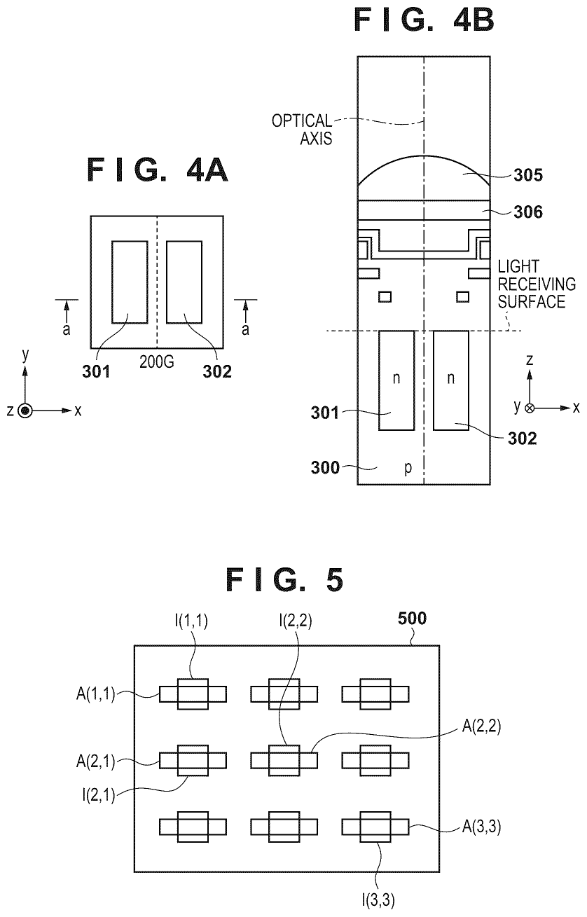

FIG. 4A illustrates one imaging pixel (e.g., 200G) as viewed from the light receiving surface side (+z direction) of the image sensor 107. FIG. 4B illustrates a cross-sectional view of the imaging pixel of FIG. 4A taken along the line a-a and viewed from the −y direction. As shown in FIG. 4B, one imaging pixel is provided with one microlens 305 for collecting incident light.

Furthermore, the imaging pixel is provided with photoelectric conversion units 301 and 302 that divides the pixel into N parts (two parts in this embodiment) in the x direction. The photoelectric conversion units 301 and 302 respectively correspond to the first focus detection sub-pixel 201 and the second focus detection sub-pixel 202. The centers of gravity of the photoelectric conversion units 301 and 302 are decentered on the −x side and +x side with respect to the optical axis of the microlens 305, respectively.

An R, G or B color filter 306 is provided (a G color filter 306 in the case of the example shown in FIG. 4A) between the microlens 305 and the photoelectric conversion units 301 and 302 in each imaging pixel. Note that the spectral transmittance of the color filter may be changed for each photoelectric conversion unit, or the color filter may be omitted.

Light incident on the imaging pixel via the imaging optical system is collected by the microlens 305, separated into color components by the color filter 306, and then received by the photoelectric conversion units 301 and 302 where it is photoelectrically converted.

In each pixel having such a configuration, a signal (signal A+B) obtained by adding signals from the photoelectric conversion units 301 and 302 is used as an image signal, and two signals (signal A and signal B) read out from the photoelectric conversion units 301 and 302 are used as a pair of focus detection signals. Note that the image signal and the focus detection signals may be read out separately, but the following may be done in consideration of the processing load. That is, the image signal (signal A+B) and one of the focus detection signals (signal A, for example) from the photoelectric conversion units 301 and 302 are read out, and the difference is taken to obtain the other focus detection signal (signal B, for example) having parallax. Alternatively, the focus detection signals (signal A and signal B) may be read out separately and added to obtain the image signal (signal A+B).

The camera 100 having the image sensor 107 configured with the pixels shown in FIGS. 3, 4A, and 4B can perform so-called phase difference focus detection, which detects a phase difference from the signal sequences of the above-mentioned pairs of focus detection signals, by using a known technique (for example, Japanese Patent Laid-Open No. 2023-95509). By using phase difference focus detection, a defocus amount in a predetermined area within the shooting angle of view can be detected, together with the direction of defocus.

Next, focus detection areas of the image sensor 107, which are areas for acquiring signal sequences of the pairs of focus detection signals for detecting phase differences, will be described with reference to FIG. 5. In FIG. 5, A(n,m) indicates a focus detection area in the n-th row and the m-th column among a plurality of focus detection areas (a total of nine, three in the x direction and three in the y direction) set in an effective pixel area 500 of the image sensor 107. Signal sequences of the pairs of focus detection signals are generated from a plurality of pixels included in the focus detection area A(n,m). I(n,m) indicates an index (AF frame) that indicates the position of the focus detection area A(n,m) on the display device 131.

Note that the nine focus detection areas shown in FIG. 5 are merely examples, and the number, positions, and sizes of the focus detection areas are not limited to these. For example, one or more areas may be set as focus detection areas in a predetermined range centered on a position specified by a user or the position of a subject detected by the subject detection unit 140. In this embodiment, the focus detection areas are arranged so that focus detection results can be obtained with a higher resolution upon acquiring a defocus map, which will be described later. For example, focus detection areas of a total of H×V points are arranged on the image sensor 107, divided horizontally into H and vertically into V.

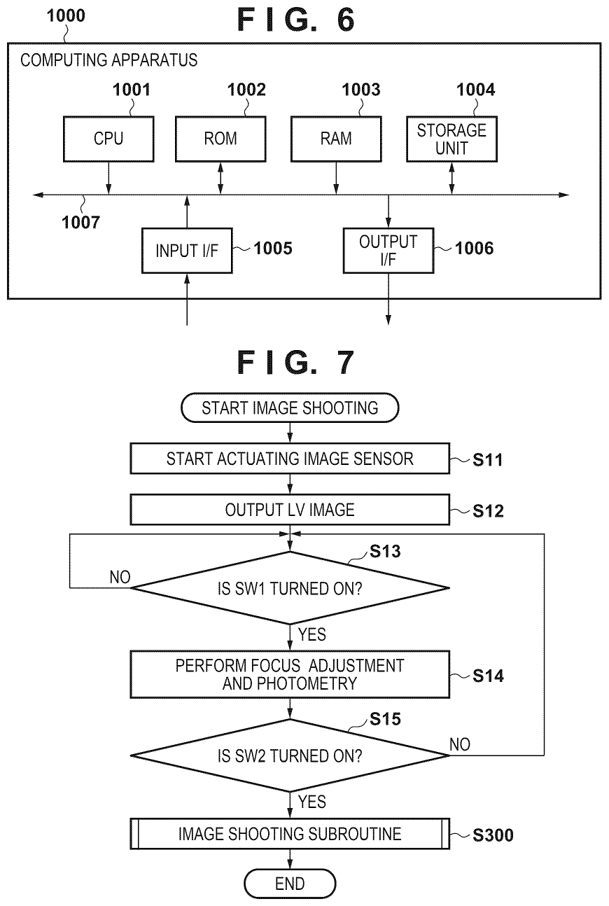

FIG. 6 is a block diagram illustrating an example of the hardware configuration of the computing apparatus 1000. The computing apparatus 1000 includes a CPU 1001, ROM 1002, RAM 1003, a storage unit 1004, an input interface (I/F) 1005, an output interface (I/F) 1006, and a system bus 1007. Each of the input I/F 1005 and the output I/F 1006 is connected to the camera 100 and the camera/lens information storage 2000

The CPU 1001 is a processor that comprehensively controls each component of the computing apparatus 1000. The RAM 1003 is a memory that functions as the main memory and work area of the CPU 1001, and the ROM 1002 is a memory that stores programs and the like used for processing within the computing apparatus 1000. The CPU 1001 uses the RAM 1003 as a work area and executes programs stored in the ROM 1002 to perform various processes, which will be described later.

The storage unit 1004 is a storage device that stores image data to be processed in the computing apparatus 1000, parameters (i.e., setting values) for the processing, etc. A HDD, an optical disk drive, a flash memory, etc. can be used as the storage unit 1004.

The input I/F 1005 is, for example, a serial bus interface such as USB or IEEE 1394. The computing apparatus 1000 can acquire the above-mentioned various information from the camera 100 via the input I/F 1005. The output I/F 1006 is, for example, a video output terminal such as DVI or HDMI (registered trademark). The computing apparatus 1000 can output image data processed by the computing apparatus 1000 to the display device 131 of the camera 100 via the output I/F 1006. In addition, it can output images to be recorded in the flash memory 133 of the camera 100.

The computing apparatus 1000 may include components other than those described above, but as they are not related to the present disclosure, detailed descriptions thereof will be omitted.

### (Image Shooting Processing)

FIG. 7 is a flowchart illustrating image shooting processing according to this embodiment and shows the process from displaying a live view image on the display device 131 of the camera 100 to shooting a still image. The camera CPU 121 controls the image shooting processing according to a computer program.

First, in step S11, the camera CPU 121 causes the image sensor actuation circuit 124 to start actuating the image sensor 107 and repeatedly acquire an electrical signal from the image sensor 107 at a predetermined cycle. From the acquired electrical signal, the camera CPU 121 acquires pairs of focus detection signals corresponding to the first focus detection sub-pixels 201 and the second focus detection sub-pixels 202 included in each of a plurality of focus detection areas A(n, m) as shown in FIG. 5 and an image signal corresponding to all pixels in the effective pixel area 500 of the image sensor 107. Then, the camera CPU 121 causes the image processing unit 125 to perform image processing on the image signal to acquire image data. Note that, in a case where the imaging pixels and the focus detection pixels are provided separately, the camera CPU 121 performs an interpolation process to obtain the image signal corresponding to the focus detection pixels.

Next, in step S12, the camera CPU 121 causes the image processing unit 125 to generate a live view (LV) image from the image data obtained in step S11, and sequentially displays the LV image on the display device 131. The LV image is a reduced image that matches the resolution of the display device 131, and the user can adjust the composition, exposure conditions, and the like while viewing the LV image. The camera CPU 121 also performs exposure adjustment based on the photometric value obtained from the image data, thereby enabling display of the LV image obtained under the adjusted exposure conditions on the display device 131. The exposure adjustment is realized by appropriately adjusting the exposure period, the aperture diameter of the diaphragm 102, and the gain to be applied to the output of the image sensor 107.

Next, in step S13, the camera CPU 121 determines whether or not a switch SW1, which instructs the start of an image shooting preparation operation, is turned on by a half-pressing of a release switch included in the operating switches 132. If the switch SW1 is not turned on, the camera CPU 121 repeats the determination in step S13 to monitor the timing at which the switch SW1 is turned on. On the other hand, if the switch SW1 is turned on, the camera CPU 121 advances the process to step S14 and performs a focus adjustment process and a photometry process.

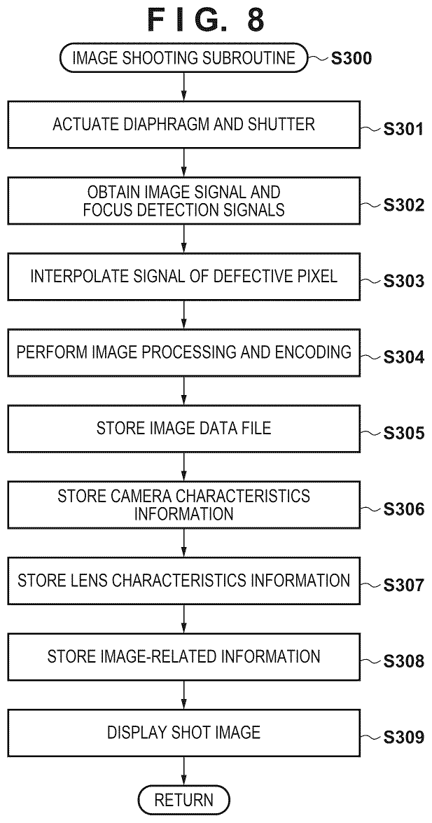

Thereafter, the camera CPU 121 advances the process to step S15, where it determines whether or not a switch SW2, which instructs the start of a shooting operation, is turned on by a full-pressing of the release switch. If the switch SW2 is not turned on, the camera CPU 121 returns the process to step S13. On the other hand, if the switch SW2 is turned on, the camera CPU 121 advances the process to step S300, where an image shooting subroutine is executed. Details of the image shooting subroutine performed in step S300 will be described later with reference to FIG. 8. When the image shooting subroutine ends, the image shooting processing ends.

In this embodiment, the focus adjustment process is performed in step S14 after the switch SW1 is detected as being on in step S13, but the timing of the focus adjustment process is not limited to this. For example, the focus adjustment process may be performed before the switch SW1 is turned on, in which case the photographer does not need to perform any preparatory action before shooting.

Next, the image shooting subroutine controlled by the camera CPU 121 in step S300 of FIG. 7 will be described with reference to the flowchart shown in FIG. 8.

In step S301, the camera CPU 121 uses the photometric value obtained in step S14 to determine exposure conditions (exposure period, aperture value, imaging sensitivity, etc.). Then, the camera CPU 121 transmits the determined aperture value to the diaphragm actuation circuit 128 to actuate the diaphragm 102, and transmits the determined exposure period to the shutter 106 to open the shutter 106. Furthermore, the camera CPU 121 causes the image sensor 107 to accumulate charge during the exposure period via the image sensor actuation circuit 124.

When the exposure period elapses and the shutter 106 closes, in step S302, the camera CPU 121 controls the image sensor actuation circuit 124 to read out signals from the image sensor 107 so that an image signal for a still image and a pair of focus detection signals can be acquired.

Next, in step S303, the camera CPU 121 causes the image processing unit 125 to perform a defective pixel correction process on the image signal read out in step S302 and converted from analog to digital.

Further, in step S304, the camera CPU 121 causes the image processing unit 125 to perform image processing such as demosaic (color interpolation) processing, white balance processing, gamma correction (tone correction) processing, color conversion processing, and edge enhancement processing, and encoding processing, on the image signal, which has undergone the defective pixel correction process, to generate image data.

In step S305, the camera CPU 121 stores the image data obtained through the image processing and encoding processing in step S304 and the pair of focus detection signals as an image data file in the flash memory 133. Note that, in a case where the image signal and only one of the focus detection signals are obtained in step S302, the image data, the read one of the focus detection signals, and the image signal are stored as an image data file in the flash memory 133.

Next, in step S306, the camera CPU 121 stores characteristics information of the camera 100 (hereinafter referred to as “camera characteristics information”) in the flash memory 133 in association with the image data stored in step S305. The camera characteristics information includes, for example, the following information:
Exposure conditions (exposure period, aperture value, imaging sensitivity, etc.)
Information on image processing performed by the image processing unit 125
Information on the light receiving sensitivity distribution of the imaging pixels and focus detection pixels of the image sensor 107
Information on vignetting of the imaging light flux in the camera 100
Information on the distance from the mounting plane of the interchangeable lens 120 to the image sensor 107 in the camera 100
Information on manufacturing errors of the camera 100.

Information on the light receiving sensitivity distribution of the imaging pixels and focus detection pixels (hereinafter simply referred to as “light sensitivity distribution information”) is information regarding sensitivities of pixels according to their distance (image height) from the optical axis on the image sensor 107. Because the light sensitivity distribution information depends on the microlens 305 and the photoelectric conversion units 301 and 302, the light sensitivity distribution information may include information on the microlens 305 and the photoelectric conversion units 301 and 302. In addition, the light sensitivity distribution information may include information regarding changes in sensitivity with respect to the angle of incidence of light.

Next, in step S307, the camera CPU 121 stores characteristics information of the interchangeable lens 120 (hereinafter referred to as “lens characteristics information”) in the flash memory 133 in association with the image data stored in step S305. The lens characteristics information includes, for example, information on the exit pupil, information on a frame of a lens barrel, etc. that blocks light beams, information on the focal length and F-number at the time of image shooting, information on the aberration of the imaging optical system, information on manufacturing errors of the imaging optical system, and information on the position of the third lens group 105 at the time of image shooting (subject distance).

Next, in step S308, the camera CPU 121 stores image-related information. The image-related information includes, for example, information related to a focus detection operation before image shooting, information related to the movement of a subject, and information related to focus detection accuracy.

Next, in step S309, the camera CPU 121 displays the shot image on the display device 131. This allows the user to easily check the shot image.

When the process of step S309 ends, the camera CPU 121 ends the image shooting subroutine.

### (Information Held by Camera 100, Computing Apparatus 1000, and Camera/Lens Information Storage 2000)

Next, the information held by the camera/lens information storage 2000, the camera 100, and the computing apparatus 1000 will be explained using the table in FIG. 9.

The camera/lens information storage 2000 stores camera information and lens information for the camera 100.

The camera information stored in the camera/lens information storage 2000 includes, for example, the resolution of display obtained from the camera 100 in advance, the resolution of an image for recording, the size of the image sensor, camera settings such as the AF frame mode, the autofocus (AF) mode such as one-shot AF or servo AF, the continuous shooting setting, and the shooting difficulty setting related to image shooting set by the photographer, the AF algorithm, camera algorithm information such as automatic exposure (AE) and the actuation sequence of continuous shooting, camera detection information such as temperature, image sensor characteristics information such as signal-to-noise (S/N) information for each ISO sensitivity, shading correction values which represent signal characteristic corrections of the image sensor and unevenness in the amount of light, a defocus conversion coefficient which converts an image shift amount into a defocus amount, focus-related correction information, information regarding correction of the best focus position for correcting the deviation between the focus detection result and the best image plane position, focus-related correction information, which is defocus error information, and general information such as the model names of the camera body 110 and the interchangeable lens 120, and firmware versions of various algorithms. Here, one-shot AF is an AF mode in which the focus is adjusted only once when the switch SW1, which instructs the start of an image shooting preparation operation in AF mode for shooting a stationary subject, is turned on. Servo AF is an AF mode in which the focus is adjusted continuously while the switch SW1 is half-pressed in AF mode for shooting a moving subject.

Note that the camera/lens information storage 2000 stores camera information not only on the camera 100 but also on a plurality of different cameras.

Furthermore, the lens information stored in the camera/lens information storage 2000 includes, for example, the range, current value, and resolution of the focal length of the interchangeable lens 120, the range, step size, and current value of the F-number, the actuation range of the focus lens and current focus information, focus control information related to the control characteristics when actuating the focus lens, sensitivity for converting a focus lens actuation amount into an image plane movement amount, image stabilization information related to the image stabilization range, current value, and correction resolution, image stabilization control information related to the control characteristics of image stabilization, diaphragm control information related to the control characteristics when actuating the diaphragm, lens frame information (position, diameter) related to vignetting, information on decrease in marginal illumination, distance information related to the focus lens position and distance, and information on point spread function.

Note that the camera/lens information storage 2000 stores lens information not only on the interchangeable lens 120 but also on a plurality of different interchangeable lenses.

The camera 100 stores the camera operation information generated by the photographer operating the camera body 110 and the interchangeable lens 120. As described above, the camera operation information includes information on framing, zooming, focus operations, release operations, and other button operations.

The computing apparatus 1000 acquires the camera information and the lens information stored in the camera/lens information storage 2000 and the camera operation information stored in the camera 100 and generates an image for display, an image for recording, subject information, which is shooting difficulty information, and various information on image shooting.

The lens information acquired by the computing apparatus 1000 includes, for example, the focal length, F-number, information regarding the settable range and current position of the focus lens, the mechanical controllability of the lens, the amount of movement (sensitivity) of the imaging plane associated with movement of the focus lens, frame information (position, diameter) regarding vignetting, information on decrease in marginal illumination, and image shooting distance (distance to the subject at which the subject is in focus) information, etc.

The camera information acquired by the computing apparatus 1000 includes, for example, general information such as model name, firmware version, an electronic viewfinder (EVF) image and still image resolutions, the size of the image sensor, and camera setting information such as an AF frame setting indicating the area/areas for AF, an AF mode setting such as one-shot AF or servo AF, a continuous shooting mode setting such as a shooting rate of continuous shooting, etc. The camera setting information includes difficulty information (a shooting difficulty setting) related to shooting set by the photographer. In addition, correction values of signal characteristics depending on the characteristics of the image sensor 107, shading correction values indicating unevenness of light amount, a defocus conversion coefficient for converting the phase difference between a pair of signals into a defocus amount, best focus correction values for correcting deviations between focus detection results and the best image plane position, etc. are included as correction values for signals used for autofocus detection. In addition, the camera information includes, as characteristics information of the image sensor 107, S/N information of signals for each ISO sensitivity, various algorithm information such as continuous shooting sequence and photometry when shooting with the camera, and algorithm information related to autofocus such as selection of AF frame and predictive AF, etc.

The camera information acquired by the computing apparatus 1000 includes information on framing, zooming, focus operations, release operations, and camera operation information related to other button operations.

### (Image Evaluation Processing)

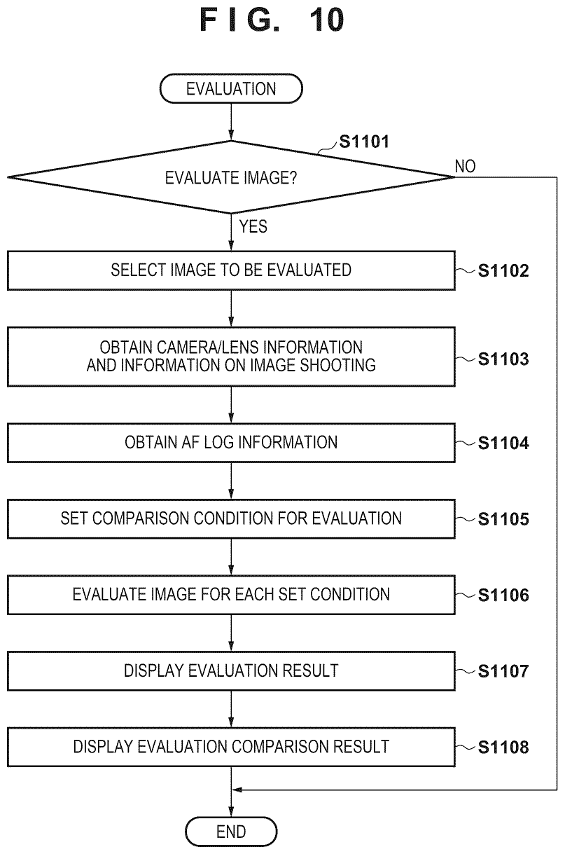

The flowchart in FIG. 10 illustrates image evaluation processing of an image captured by the camera 100 of this embodiment. This process may be performed within the camera 100, or may be performed by the computing apparatus 1000 by transmitting the necessary data to the computing apparatus 1000. In a case where the image evaluation processing is performed by the computing apparatus 1000, the evaluation results may be displayed using a display device of the computing apparatus 1000, or the evaluation results may be sent to the camera 100 and displayed on the display device 131. In the following explanation, the processing is assumed to be performed within the camera 100 under the control of the camera CPU 121.

First, in step S1101, the camera CPU 121 determines whether or not to evaluate a captured image. If the captured image is to be evaluated, the processing proceeds to step S1102, and if the captured image is not to be evaluated, the processing ends. The start and end of image evaluation can be selected by using the operating switches 132 to operate a selection button provided on the display 131. Also, an evaluation mode may be provided and set to “ON” to automatically start evaluation.

In step S1102, the camera CPU 121 selects an image to be evaluated (hereinafter, referred to as an “evaluation target image”) from images stored in the flash memory 133. As the evaluation target image, a single image may be selected, or any number of multiple images may be selected, or all images in any folder may be selected at once. Further, a series of images captured by continuous shooting may be automatically selected, and the shooting evaluation may be performed on them, in which case, by evaluating the series of images, it is possible to evaluate the scene.

In step S1103, information on image shooting of the selected evaluation target image is acquired. The information on image shooting refers to various information of the camera 100 and the interchangeable lens 120 used at the time of shooting. The information on image shooting includes settings information of the camera 100 and the interchangeable lens 120 used at the time of shooting, such as focal length, F-number, continuous shooting mode, AF mode, subject detection AF tracking setting, AF frame setting, shutter method, etc.

Next, in step S1104, AF log information attached as meta information of the evaluation target image is obtained. The AF log information includes the following information:
Defocus information of the evaluation target image.
AF frame setting information.
Tracking information: Use a subject detection AF function to focus on a set detected object. For example, a person, an animal, a vehicle, etc. is automatically detected using a set algorithm.
Servo AF characteristics: Various parameters for servo AF are assigned to set the priority of focusing.
Action recognition information: Posture information of a subject, information on which a subject is recognized preferentially in a case where the subject performs a specific action.
Shutter method information: A shutter mode, such as a mechanical shutter mode that actuates a mechanical shutter or an electronic shutter mode that determines the exposure period only by the image sensor without using a mechanical shutter, can be selected, and setting information of continuous shooting frame rate, such as 30, 20, or 10 frames per second of the electronic shutter, can be checked.

Next, in step S1105, a comparison condition for evaluation is set. Here, the comparison condition for evaluation is a setting condition different from the setting condition when the evaluation target image was shot, and includes, for example, automatic setting by the camera CPU 121, settings of a focus adjustment condition different from those set when the image was shot by the user, settings of the camera or the interchangeable lens different from those set when the image was shot by the user, and so forth.

Next, in step S1106, evaluation is performed using the various information and settings acquired in steps S1103 to S1105 described above. Here, the defocus amount of each focus detection area of the evaluation target image and the degree of focus of the evaluation target image are obtained from the AF log information, and a defocus amount is obtained using the comparison condition for evaluation set in step S1105.

In step S1107, the evaluation result (defocus map) of the evaluation target image is superimposed on the evaluation target image and displayed on the display device 131. In this embodiment, the defocus map represents the defocus amounts in different display forms such as different colors and patterns.

In addition, in step S1108, the defocus map obtained in step S1106 using the comparison condition for evaluation is superimposed on the evaluation target image and displayed on the display device 131. The defocus map in step S1107 is based on defocus information of the evaluation target image obtained from AF log information attached as meta information of the evaluation target image, and the defocus map in step S1108 represents an evaluation result of an image after the comparison condition has been applied.

In addition, when the degree of focus of the evaluation target image is higher than the degree of focus obtained by using the comparison condition for evaluation, it is not necessary to perform the display in step S1108. In addition, if there are a plurality of comparison conditions for evaluation, in step S1108, among defocus maps corresponding to the comparison conditions for evaluation, defocus map/maps having degree/degrees of focus higher than the degree of focus of the evaluation target image may be displayed sequentially, or the defocus map of the comparison condition for evaluation having the highest degree of focus may be displayed.

Also, instead of sequentially performing the display in step S1107 and the display in step S1108, the images may be displayed side by side on one screen, which makes it easier to compare the evaluation results.

Further, the display in steps S1107 and S1108 may be performed on a display device of a PC or the like (not shown) connected to the camera 100.

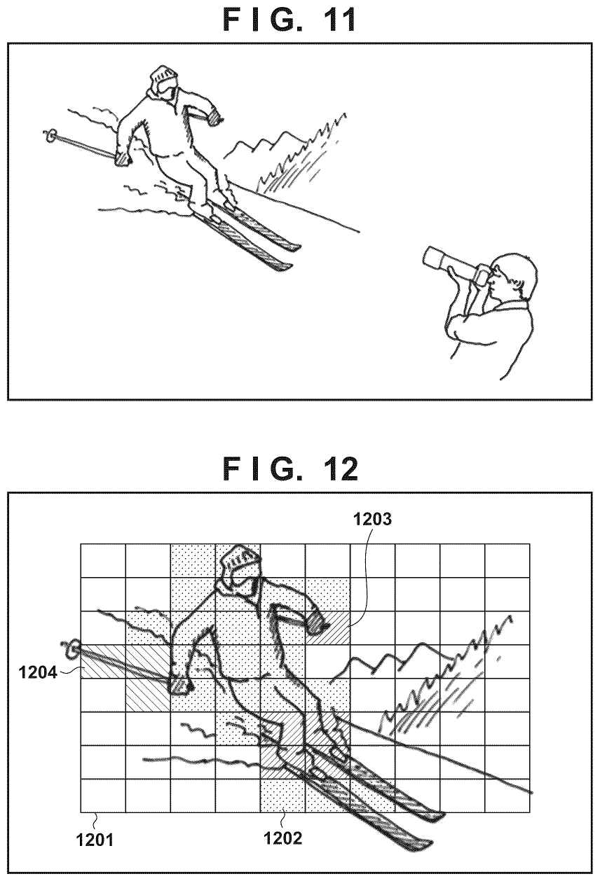

The processing in FIG. 10 will be described below using a specific example. Here, as shown in FIG. 11, a case will be described in which an image of a person skiing is the image to be evaluated.

### Evaluation Example 1

FIG. 12 illustrates an ideal focus state in which many of the blocks in the evaluation target image, including the person skiing, are in focus, and a defocus map 1201 is superimposed on the evaluation target image. Here, for each of the blocks displayed in a 10×8 array in the center of the image, either a plus (front focus) or minus (rear focus) direction with respect to a defocus amount of 0 (in-focus position) is displayed on the captured image. Among the blocks, an in-focus block 1202 with a hatched pattern indicates a defocus amount near 0 (for example, the absolute value of the defocus amount is less than a threshold). An in-focus block 1202 indicates that the portion of the image within this block is in focus, and many of the blocks including the person skiing are shown as in-focus blocks 1202. A front-focused block 1203 with upward slanting lines indicates a state in which the defocus amount is positive (the defocus amount is equal to or greater than a positive threshold), indicating that the portion of the image within this block is in front focus. A rear-focused block 1204 with downward slanting lines indicates a state in which the defocus amount is negative (the defocus amount is equal to or less than a negative threshold), indicating that the portion of the image within this block is in rear focus.

The defocus map shown in FIG. 12 is an example and does not need to be in blocks of a 10×8 array. The defocus map may be displayed with finer blocks. Although the defocus amounts of the area roughly including the main subject are displayed, the defocus amounts of the entire captured image may be displayed. Furthermore, the defocus map shown in FIG. 12 is displayed in three stages, near focus, front focus, and rear focus, but may be displayed in finer stages, or the defocus amounts may be displayed in units of mm, etc.

The degree of focus is evaluated based on whether or not the defocus amount corresponding to the subject position is within a predetermined threshold range using a defocus map obtained under a different setting condition. For example, the predetermined threshold may be within ±1F8, where F is the aperture value and 8 is the diameter of the permissible circle of confusion.

Furthermore, the degree of focus is evaluated such that the evaluation result of the degree of focus is o if the defocus amount of the subject position is within a predetermined threshold range centered around a defocus amount of 0 using the defocus map, and otherwise the evaluation result of the degree of focus is x. Each image may be judged as ∘ or x, and the proportion of images with o among all images captured in a series of continuous shooting, such as related images, etc. may be evaluated as an in-focus rate.

In the case of FIG. 12, the focus state is ideal and the evaluation result of the degree of focus is ∘, so the evaluation result of the degree of focus (∘), for example, may be displayed in FIG. 12.

### Evaluation Example 2

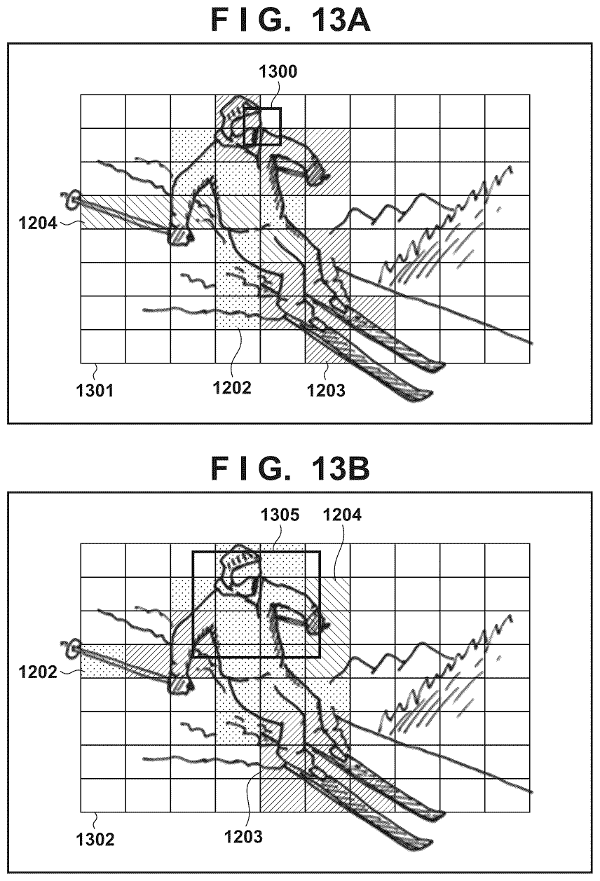

FIG. 13A illustrates an example in which the evaluation target image is not in an ideal focus state as shown in FIG. 12. A case in which the comparison condition for evaluation is automatically set by the camera CPU 121 in step S1105 will be described.

In step S1106, a defocus map 1301 that is based on the defocus amounts calculated using information on image shooting in the meta information of the camera (product name CA) and the lens (product name LA) at the time of image shooting is superimposed on the evaluation target image, and is displayed in step S1107. FIG. 13B shows an example in which a defocus map 1302 obtained in step S1106 based on the defocus amounts calculated in a case where focus control different from that at the time image shooting is performed using a comparison condition for evaluation is superimposed on the evaluation target image, and is displayed in step S1108.

Here, among the setting conditions that can be set in the camera (product name CA) and lens (product name LA) used when the evaluation target image was shot, setting conditions that differ from the condition set at the time of the image shooting are sequentially applied to evaluate the focus state, and the setting condition that produced the highest evaluation result is presented.

In FIG. 13A, an AF frame 1300 indicates an area used in the focus adjustment process when shooting the evaluation target image. FIG. 13A shows that the focus adjustment process was performed using one-point AF based on the AF frame setting information of the camera, together with the defocus map 1301. In the example shown in FIG. 13A, the AF frame 1300 covers half of the subject's face. The focus is therefore set farther away than the main subject due to the influence of the background, and the degree of focus is deteriorated. It can be seen that front-focused blocks 1203 are superimposed on the subject's face, and the face is not in focus. In addition, compared to the defocus map 1201 shown in FIG. 12, it can be seen that the number of in-focus blocks 1202 is small, and there are fewer in-focus portions overall.

By contrast, FIG. 13B shows the defocus map 1302 obtained in a case where a zone AF frame 1305 is set, wherein the zone AF frame 1305 has a wider area than the one-point AF frame 1300, and the highest evaluation result is obtained among the setting conditions that can be set in the combination of a camera (product name CA) and a lens (product name LA). In the process of step S1106, the defocus amounts when changed to zone AF are calculated based on the focus control information of the one-point AF actually used during shooting, and the result is displayed as the defocus map 1302, superimposed on the evaluation target image.

By displaying the defocus map 1302 obtained as a result of changing the setting from one-point AF to zone AF, it is possible to compare the defocus map 1301 in one-point AF with the defocus map 1302 in zone AF. At this time, the one-point AF frame 1300 and the zone AF frame 1305 are respectively displayed as the setting condition.

In FIG. 13B, more in-focus blocks 1202 are superimposed on the subject than in FIG. 13A, and it is shown that by using zone AF, an image in which the subject is in focus without being affected by the background can be obtained. In this way, in the examples shown in FIGS. 13A and 13B, it can be confirmed that a better focused image can be obtained by shooting with zone AF, which performs focus adjustment using focus detection signals in a wider area than one-point AF.

In the above-mentioned evaluation example 2, the evaluation result obtained by automatically selecting the setting condition that presents the highest evaluation result from among a plurality of setting conditions is displayed, but the method of selecting the setting condition is not limited to this, and the photographer may select it. In that case, in step S1108, the camera CPU 121 displays selectable setting conditions on the display device 131 based on the combination of the camera (product name CA) and the lens (product name LA), and the photographer selects one of them. The camera CPU 121 calculates the defocus amount based on the selected setting condition and superimposes and displays a defocus map and the selected setting condition on the evaluation target image.

This allows the photographer to know which setting condition will give the highest evaluation result.

### Evaluation Example 3

As the comparison condition for evaluation set in step S1105, it is possible to use a setting condition that can be set on a camera (product name CB) other than the camera (product name CA) used to capture the evaluation target image. That is, camera information of a camera (product name CB) other than the camera (product name CA) that shot the evaluation target image is obtained from the camera/lens information storage 2000, and information required for AF is obtained from the existing lens information. Then, evaluation can be performed in a case where the functions that can be set on the camera (product name CB) are set as a setting condition. In this case, in the process of step S1106, the defocus amount in a case where the setting condition is changed to the setting condition that can be set on the camera (product name CB) is calculated based on the focus control information used at the time of shooting, and in step S1108, the result is displayed as a defocus map superimposed on the evaluation target image.

In this way, by rewriting the focus-related information of the evaluation target image with the information of the setting conditions of the camera (product name CB), it is possible to compare the AF performance difference between the camera (product name CA) and the camera (product name CB).

In addition, interchangeable lenses can be compared in the same way as cameras. That is, lens information of a lens (product name LB) different from the lens (product name LA) used to shoot the evaluation target image is obtained from the camera/lens information storage 2000, and information necessary for AF is obtained from the existing lens information. Then, evaluation can be performed if the functions that can be used in the lens (product name LB) are set as a setting condition. In this case, in the process of step S1106, the defocus amount in a case where the setting condition is changed to that of a function that can be used in the lens (product name LB) is calculated based on the focus control information used at the time of shooting, and in step S1108, the result is displayed as a defocus map superimposed on the evaluation target image.

In this way, it is possible to obtain a defocus amount different from that of the evaluation target image by using a combination of focal length, F-number, etc. different from those used at the time of shooting the evaluation target image. As a result, it is possible to compare and confirm the defocus information in a case where the lens (product name LA) is used and the defocus information in a case where the lens (product name LB) is used.

This allows differences in performance between new products, etc. to be confirmed for each shooting scene. In this way, because the performance of cameras, lenses, etc. can be confirmed before purchasing them, a photographer can select a camera and a lens that suit their needs and can use the information when considering the purchase of a new product.

### Evaluation Example 4

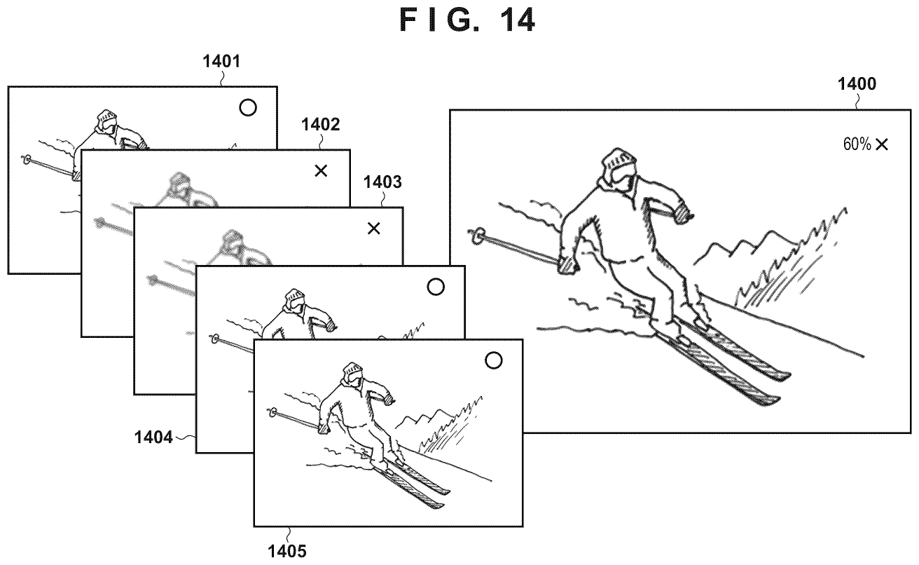

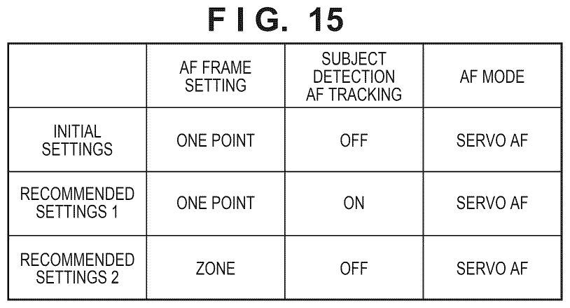

Next, using FIG. 14, an example of calculating the degrees of focus of a series of continuously shot images by performing the image evaluation processing shown in FIG. 10 will be explained.

FIG. 14 illustrates an example of the evaluation results in a case where a series of images of a subject skiing as shown in FIG. 11 are taken by a photographer in continuous shooting mode and are used as the evaluation target images. Based on the defocus amounts of the series of shot images 1401 to 1405 calculated in step S1106, the determination of each image is performed such that, if the defocus amount of an image is within a predetermined threshold range centered on the defocus amount of 0, the evaluation result of the degree of focus is o, and otherwise the evaluation result of the degree of focus is x. The evaluation of each setting condition in step S1106 described above is performed, and the evaluation result of the degree of focus, o or x, is displayed on each image. Further, the ratio of o in the series of images 1401 to 1405 obtained by continuous shooting is displayed as the degree of focus on a representative image of the series of images. FIG. 14 shows an example in which images 1402 and 1403 are out of focus images and the evaluation result is x, and images 1401, 1404, and 1405 are in focus images and the evaluation result is o.

Further, the last image 1400 shows an example in which the in-focus rate of the evaluation result of the series of images 1401 to 1405 is 60%. Here, in a case where the in-focus rate of the degrees of focus of the series of images is 60%, x is displayed, and if the in-focus rate of the degrees of focus is 70%, A may be displayed, and if the in-focus rate of the degrees of focus is 80%, o may be displayed, so that the judgment result of the degree of focus is displayed in an easy-to-understand manner to the photographer. Note that the display of the symbol may be freely set, or only the in-focus rate of the degree of focus (%) may be displayed without displaying the symbol.

In the present embodiment, the degree of focus is calculated in two stages, o or x, but the method of determining the degree of focus described here is only an example and other methods can be used. Dispersion and the like may be displayed using the unit mm of defocus calculation.

### Evaluation Example 5

FIG. 15 is a table illustrating the setting condition of the evaluation target image and examples of recommended setting conditions. The columns include examples of items whose settings can be changed.

Examples of camera information setting items whose setting conditions can be changed in the camera (product name CA) and lens (product name LA) used when shooting an image include AF frame setting, tracking that enables subject detection AF, and AF mode that switches between one-shot AF and servo AF (frequency of focus adjustment) and are shown in FIG. 15.

In FIG. 15, the initial settings are the settings at the time of shooting the evaluation target image. Recommended settings 1 and recommended settings 2 are setting examples showing combinations of recommended comparison conditions for evaluation set in step S1105 of FIG. 10. Note that the number of recommended settings is not limited to two.

As described in Evaluation Example 1, the best evaluation settings that maximize the degree of focus can be found by changing all combinations of all possible setting conditions and evaluating degrees of focus in step S1106 of FIG. 10. However, this requires a large computational load. In contrast, the computational load can be reduced by changing combinations of settings that will be effective at improving the degree of focus relative to the initial settings.

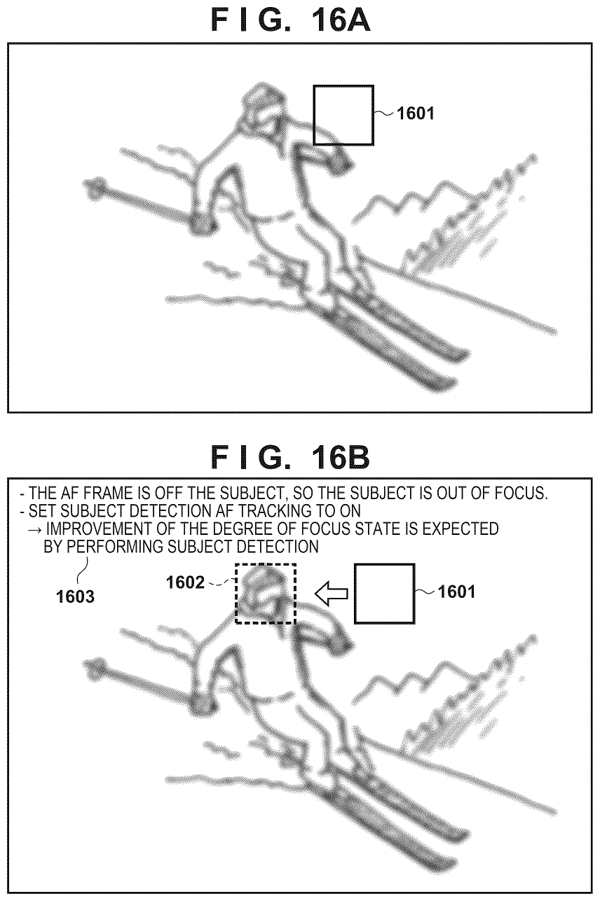

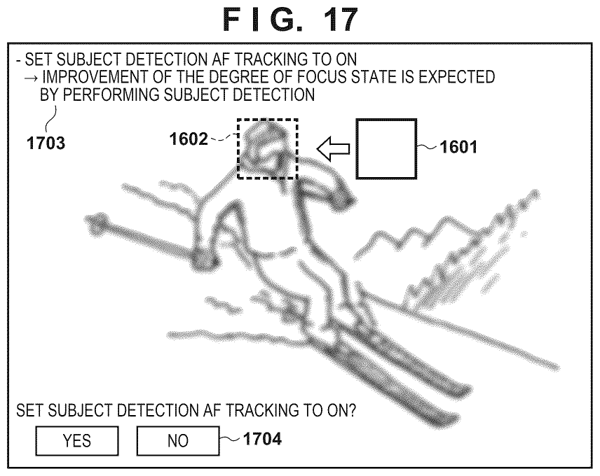

Using the recommended settings shown in FIG. 15, settings that are effective at improving the degree of focus will be described with reference to FIGS. 16A, 16B, and 17.

With the set initial settings shown in the example of FIG. 15, the following situations are considered factors that cause a photographer to move an AF frame 1601 away from the subject. With a combination of one-point AF and tracking being off, as shown in FIG. 16A, the AF frame 1601 visible in the viewfinder is fixed. This means that the photographer needs to keep the AF frame 1601 on the subject, but the unexpected movement of the subject makes this difficult.

With recommended settings 1, even if one-point AF is selected, subject detection is performed by turning on AF tracking so that the AF frame 1602 can automatically capture and continue to track the subject, as shown in FIG. 16B. Therefore, as long as the photographer places the AF frame on the subject at the start of shooting and then starts tracking, the photographer can concentrate only on keeping the subject within the angle of view, which reduces the difficulty of framing.

With recommended settings 2, a zone AF setting with a wider AF area compared to the one-point AF setting is selected. With this setting, subject detection AF tracking is turned off and the area of the AF frame is widened, making it easier to capture the subject, thereby reducing the difficulty of framing.

As described above, by selecting recommended settings based on factors that degrade the degree of focus, it is possible to find setting conditions that can improve the degree of focus more efficiently. Note that the settings illustrated in FIG. 15 are merely examples, and various other settings may be used. For example, a change in the shutter actuation method, a change in the servo AF characteristics, etc. may be included.

Furthermore, the settings related to AF frame and subject detection AF tracking used in the actually shot image can be changed to generate and evaluate an evaluation result image that shows the change in defocus amount using an algorithm for a camera setting or a lens combination that is different from those used when the image was shot. A new AF frame can be selected by applying, after changing the settings, an algorithm for setting the AF frame using the image and the defocus map information at the time of acquiring the image. Also, a new subject detection area can be set by applying to an image, after changing the settings, an algorithm for tracking.

### (Display of Information Related to Shooting Settings)

Next, using FIGS. 16A, 16B, and 17, display of information about a shot image related to a photographer's framing technique based on the evaluation results of the degree of focus described above will be explained.

FIG. 16A illustrates an example of an out-of-focus image in which the defocus amount is large and the result of the degree of focus is evaluated as x. In this image, the AF frame does not keep up with the movement of the subject skiing at high speed, and the AF frame 1601 is off the subject's face, resulting in a poor degree of focus. It is presumed that the influence of the shutter method, the selection of the AF frame, the angle of view determined by the focal length of the lens, etc. make it difficult to maintain an in-focus state under the setting condition set by the photographer. In such a situation, a suggestion of setting conditions based on image evaluation is displayed on the display device 131 of the camera or a display device of a PC, etc. along with the display of the captured image.

FIG. 16B illustrates an example of a setting condition suggested in step S1108 as a result of evaluating various shooting sequences using the image in FIG. 16A. The setting condition suggested here is to set subject detection AF tracking to ON.

In step S1106, degrees of focus are calculated using various combinations of setting conditions based on the information acquired in steps S1103 to S1105, and setting conditions that provide a higher degree of focus are found. For example, in FIG. 16A, the AF frame 1601 is off the subject, whereas the evaluation result of step S1106 indicates that a calculated degree of focus will be improved if the AF mode is set so as to perform tracking for the subject detection AF based on the AF log information obtained in step S1104.

Therefore, in the process of presenting the suggested setting condition in step S1108, a sentence 1603 is displayed, as shown in FIG. 16B, to inform the photographer that the degree of focus will be improved by turning on subject detection AF tracking. Here, the AF frame is left unchanged as one-point AF, and the photographer is presented with the suggestion to turn on subject detection AF tracking. It is possible to select whether or not to display the explanation regarding the suggested setting condition as the sentence 1603 by adjusting a setting of the camera 100. Also, by displaying the dotted line 1602 indicating the tracking AF frame, it is indicated that the AF frame will move to the face of the subject from the one-point AF frame 1601, and that the focusing accuracy will improve.

FIG. 17 illustrates, on the image of FIGS. 16A and 16B, “YES” and “NO” options 1704 for prompting the photographer to select whether or not to change the setting condition by turning subject detection AF tracking on, thereby allowing the photographer to change a setting that can further improve the degree of focus. Note that although a display prompting the photographer to change the setting has been described, the camera may automatically change the setting.

In addition, by the photographer performing shooting after changing the setting and evaluating the shot image to quantify the degree of focus, the photographer can know the true capabilities of his/her framing skills. By analyzing the causes of poorer degrees of focus and displaying the optimal settings, the photographer's framing skills can be improved.

As described above, according to this embodiment, the photographer can check the defocus amount and evaluation result of the degree of focus for each setting condition and change the setting condition in response to the suggested setting condition, enabling the photographer to shoot an image with a good degree of focus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-117232, filed Jul. 22, 2024, the entirety of which is incorporated herein by reference.

What is claimed is:

1. An image processing apparatus comprising one or more memories storing a program and one or more processors that, upon execution of the stored program, are configured to function as:
an acquisition unit that acquires, from a storage unit, a captured image, information indicating a focus state of the image, and information indicating first settings at the time of image capture;
a calculation unit that calculates an alternative focus state of the image as if it was captured using second settings different from the first settings; and
a control unit that displays on a display unit information representing the focus state acquired by the acquisition unit and information representing the alternative focus state calculated by the calculation unit.

2. The image processing apparatus according to claim 1, wherein the first settings and the second settings include at least one of an area of an image to be focused, whether to perform focus adjustment by tracking a subject, a frequency of performing focus adjustment, or an aperture value.

3. The image processing apparatus according to claim 1, wherein the acquired information indicating a focus state of the image is information that enables a pair of focus detection signals having a phase difference to be obtained.

4. The image processing apparatus according to claim 3, wherein
the one or more processors, upon execution of the stored program, further function as a generation unit that generates a defocus map representing focus state,
wherein the generation unit generates a first defocus map of the image using the pair of focus detection signals having a phase difference and generates a second defocus map of the image representing the alternative focus state calculated by the calculation unit.

5. The image processing apparatus according to claim 4, wherein the calculation unit calculates the alternative focus state based on the pair of focus detection signals having a phase difference, the first settings, and the second settings.

6. The image processing apparatus according to claim 4, wherein the control unit sequentially displays a plurality of images on which the first defocus map and the second defocus map are superimposed, respectively.

7. The image processing apparatus according to claim 4, wherein the control unit displays a plurality of images on which the first defocus map and the second defocus map are superimposed, respectively, side by side.

8. The image processing apparatus according to claim 1, wherein the control unit further displays information indicating the second settings used when the calculation unit calculates the alternative focus state.

9. The image processing apparatus according to claim 1, wherein the control unit further displays an option to change settings of an image capturing apparatus that captured the image to the second settings.

10. The image processing apparatus according to claim 1, wherein
the one or more processors, upon execution of the stored program, further function as an evaluation unit that evaluates focus state,
wherein the captured image acquired by the acquisition unit comprises a series of a plurality of images captured successively, and the evaluation unit evaluates each one of the plurality of images in the series and determines an evaluation result of the series of the plurality of images based on the evaluation of each image in the series, and
wherein the control unit displays on the display unit the evaluation result of the series of the plurality of images by superimposing the evaluation result on any one of the plurality of images in the series.

11. The image processing apparatus according to claim 1, wherein
the one or more processors, upon execution of the stored program, further function as an evaluation unit that evaluates focus state,
wherein the control unit displays on the display unit information representing the alternative focus state calculated by the calculation unit only when a second evaluation of the alternative focus state calculated by the calculation unit indicates a higher degree of focus than a first evaluation of the focus state of the image acquired by the acquisition unit.

12. The image processing apparatus according to claim 11, wherein
the calculation unit calculates a plurality of alternative focus states using a plurality of second settings different from the first settings, and
the control unit displays on the display unit information representing an alternative focus state from among the plurality of alternative focus states calculated by the calculation unit corresponding to a second evaluation that indicates a higher degree of focus than the first evaluation.

13. The image processing apparatus according to claim 12, wherein the plurality of second settings is a plurality of combinations of predetermined functions among functions of an image capturing apparatus that captured the image that can be set as the second settings.

14. The image processing apparatus according to claim 11, wherein
the calculation unit calculates a plurality of alternative focus states using a plurality of second settings different from the first settings, and
the control unit displays on the display unit information representing an alternative focus state from among the plurality of alternative focus states calculated by the calculation unit corresponding to the second evaluation that indicates the highest degree of focus that is higher than the first evaluation.

15. The image processing apparatus according to claim 1, wherein the second settings are settings of functions of an image capturing apparatus that captured the image.

16. The image processing apparatus according to claim 15, wherein the one or more processors, upon execution of the stored program, further function as a second acquisition unit that acquires information about the functions from the image capturing apparatus.

17. The image processing apparatus according to claim 1, wherein the second settings are settings of functions of a second image capturing apparatus different from a first image capturing apparatus that captured the image.

18. The image processing apparatus according to claim 1, wherein the one or more processors, upon execution of the stored program, further function as a second acquisition unit that acquires information about the functions from the second image capturing apparatus.

19. An image capturing apparatus comprising:
an image processing apparatus comprising one or more memories storing a program and one or more processors that, upon execution of the stored program, are configured to function as:
an acquisition unit that acquires, from a storage unit, a captured image, information indicating a focus state of the image, and information indicating first settings at the time of image capture;
a calculation unit that calculates an alternative focus state of the image as if it was captured using second settings different from the first settings; and
a control unit that displays on a display unit information representing the focus state acquired by the acquisition unit and information representing the alternative focus state calculated by the calculation unit; and
an image sensor,
wherein the image is captured by the image sensor and stored in the storage unit.

20. An image capturing system comprising:
a first image capturing apparatus;
an image processing apparatus comprising one or more memories storing a program and one or more processors that, upon execution of the stored program, are configured to function as:
an acquisition unit that acquires, from a storage unit, an image captured by the first image capturing apparatus, information indicating a focus state of the image, and information indicating first settings at the time of image capture;
a calculation unit that calculates an alternative focus state of the image as if it was captured using second settings different from the first settings; and
a control unit that displays on a display unit information representing the focus state acquired by the acquisition unit and information representing the alternative focus state calculated by the calculation unit,
wherein the second settings are settings of functions of a second image capturing apparatus different from the first image capturing apparatus that captured the image; and
a storage device that stores information about the functions of the second image capturing apparatus.

21. An image processing method comprising:
acquiring, from a storage unit, a captured image, information indicating a focus state of the image, and information indicating first settings at the time of image capture;
calculating an alternative focus state of the image as if it was captured using second settings different from the first settings; and
displaying, on a display unit, information representing the acquired focus state and information representing the calculated alternative focus state.

22. A non-transitory computer-readable storage medium, the storage medium storing a program that is executable by a computer, wherein the program includes program code for causing the computer to execute an image processing method comprising:
acquiring, from a storage unit, a captured image, information indicating a focus state of the image, and information indicating first settings at the time of image capture;
calculating an alternative focus state of the image as if it was captured using second settings different from the first settings; and
displaying, on a display unit, information representing the acquired focus state and information representing the calculated alternative focus state.
